(19) United States
(12) Patent Application Publication
(10) Pub. No.: US 2007/0266527 A1
(43) Pub. Date: Nov. 22, 2007

(54) Semi-flexible handle

(76) Inventor: Chien-Hung Chen, Xiamen (CN)

Correspondence Address: GREER, BURNS & CRAIN, 300 S WACKER DR, 25TH FLOOR, CHICAGO, IL, 60606, US

(21) Appl. No.: 11/639,699

(22) Filed: Dec. 14, 2006

(30) Foreign Application Priority Data
May 18, 2006 (CN) 200620084553.0

(51) Int. Cl. B25G 1/10

(52) U.S. Cl. 16/431

(57) ABSTRACT

A semi-flexible practical handle, includes on a rigid main part a plane. In the waist of the side opposite to this plane the inner-sink space with U-shaped cross-section is provided, which stretches toward the plane and holds gel. A U-shaped inner clip flange is set with the two ends of the rubber lagging respectively corresponding to the two ends of the U-shaped groove to clip with it, which makes its waist seal the gel in the inner-sink space. A gland is used to make tightly press on the plane of the main part the extending part stretching inwardly at the opens in the two ends of the rubber lagging, and fix it to the main part.

### TECHNICAL FIELD OF THE INVENTION

The present utility model relates to the handles of hand-held devices, such as handles of cases or bags.

### BACKGROUND OF THE INVENTION

In the existing hand-held devices such as umbrellas and walking sticks, their flexible handles generally include the rigid main part with a hole for the middle rod to get in on the top, the rubber lagging covering the periphery of the main part and the gel clipped in the vacant cavity defined between the rubber lagging and the main party. In order to avoid the leak of the gel, The annulars are respectively set in the peripheries of the two ends of the main part while in the two ends of the rubber lagging the inner clip flanges are respectively set to match the above-mentioned and clipped with them, and at least a gland able to fixed with the main part is used to press tightly the upper or the lower part of the rubber lagging, which makes the rubber lagging tight so as to realize the seal between the main part and the rubber lagging. When a man exerts force to hold the flexible handle, the rubber lagging will press the gel and the gel under pressure will be changed at once. Thus, the external shape of the rubber lagging will get well with the holding of the man. Therefore, the man will feel very comfortable. When the external force is get rid off, the transformed gel will move gradually in it and the rubber lagging will gradually recover. However, when a man exerts a great force, for instance, when we hold the handle to lift or move the case, we wish to directly touch part of our hand on the main part of the handle to make it easy to exert force.

### SUMMARY OF THE INVENTION

The present utility model is to provide a semi-flexible handle. When a man exert force to hold it, part of its external shape changes to get well with the holding of a man, which makes a man feel comfortable in one part and another part directly touching its rigid part so as for him easy to exert force.

The technical project of present utility model is: a semi-flexible handle, comprising: a rigid main part, a rubber lagging installed in the main part and a gel clipped in the vacant cavity defined between the main part and the rubber lagging, wherein in the waist of the first side an inner-sink space with a U-shaped cross-section is provided, which stretches toward an opposite second side and holds gel. In the main part the second side opposite to the first one defines a plane. At the two ends of the first side in the main part, the U-shaped grooves are respectively provided, which stretch toward the second side. The cross-section of the rubber lagging is U-shaped. The inner-clip flanges of the two ends of the rubber lagging, which corresponds to the above-mentioned U-shaped grooves are respectively set and clipped with said grooves. The two sides of the rubber lagging stretch inwardly at the opening. The extending parts of said two sides are respectively linked onto the second side of the main part. Said waist of the rubber lagging seals the gel in the inner-sink space of the waist of the main part. A gland tightly presses the extending parts of the rubber lagging on the second side of the main part, and said gland is fixed to the main part.

In the preferred structure, at the two ends of the first side in the above-mentioned main part, the U-shaped grooves are respectively set, which stretches toward the second side. The inner-clip flanges of the two ends of the rubber lagging, which corresponds to the above-mentioned grooves with U-shaped cross section are respectively set and clipped with said grooves. Thus, the double seal will be realized between the two ends of the main part and the rubber lagging.

In a kind of preferred structure, the groove is provided in the second first side of the above-mentioned main part. The two upper raised flanges positioned in the two sided walls of the groove are respectively formed to get to the second side. There is an inner clip groove provided in each of the roots of the bottom ends of the extending parts of the two sides of the rubber lagging. The extending parts of the two sides of the rubber lagging are respectively connected onto the second side of the main part. The inner-clip groove provided in each root of the extending-part bottom end is clipped with the corresponding upper raised flange. Thus, the closer seal will be made between the two sides of the main part and the rubber lagging.

Especially, there is a straight clip groove provided in each upper part of the extending parts of the two sides of the rubber lagging. The straight clip grooves respectively divide the upper parts of the extending parts of the two sides of the rubber lagging into two raised lines stretching in the direction of the length. The bottom of the gland opens outwardly, and on the periphery a hem is provided which can cover and contain the tops of the extending parts of the two sides of the rubber lagging and the second side of the main part. In each of the two sides of the lower portion of the gland which stretch in the direction of length, there is a straight clip groove which provides a clip flange from the root part of the hem. The gland presses tightly the two sides' extending parts of the rubber lagging on the second side of the main part. The raised lines formed inside the upper parts of the two extending parts of the rubber lagging are put into the gland. The outer raised lines are respectively clipped into corresponding chutes of the lower portion of the gland which stretch in the direction of the length. The clip flanges of the two sides of the lower portion of the gland are respectively put into the corresponding chutes in the rubber lagging which stretch in the direction of the length. The part, which stretches in the direction of length, of the hem of the lower portion of the gland, covers the tops of the two sides' extending parts of the rubber lagging. The pressure of the gland over the rubber lagging focus on the edges of the two sides of the main part matching with the rubber lagging. Therefore, the seal is better.

In another preferred structure, at least the withstanding mechanism is fixedly installed in one of the ends of the above-mentioned main part. This mechanism presses the end of the rubber lagging to the end surface of the main part in same side direction. We can make use of this mechanism to prevent against loose of the ends of rubber lagging.

The suggestion is: The withstanding mechanism is a ring or lid. A ring or lid is fixed in the outer raised part of the middle of the same side's end part of the main part.

A structure to avoid gel and rubber lagging to install the press buttons in the gland and the main part is: The via holes are provided in the above-mentioned gland for the top surface of the press button to pass through. The main part of the press button is installed in the space defined between the grooves of the second side of the main part and the gland. It is suitable for the handles of cases or bags.

In the preferred structure for the press buttons, in the middle part of the press button above-mentioned the surface of the press button is raised. A horizontal pin stretches out from each of the two sides. In each horizontal pin, a guiding hole is set to match with the two raised guiding pillars to guide the up and down movement of the press button set in the grooves of the second side of the main part. The spring is set between the bottom of the press button and the grooves of the second side of the main part. Thus, the height can be controlled to be rather low while the length quite long.

Especially, the inner hole, which opens downwardly, is set in the middle of the press button above-mentioned. The spring is installed in the space defined between the bottom of the inner hole of the middle of the press button and the grooves of the second side of the main part. The inner hole can be used to make the spring enough height, which means that the spring has enough recovery force and the control force for the press button is large.

Another structure to avoid the gel and the rubber lagging to install the press buttons in the gland and the main part is: the via hole is provided in the gland above-mentioned for the end surface of the press button to pass through. In the press button via hole of the main part corresponding gland, the press button hole is opened. A spring is installed in the bottom of the press button hole. The press button which passed through the press button hole of gland is installed in the press button hole of the main part. Therefore, the horizontal size may be controlled to be rather small while the height of the press button quite large. It is suitable for the hand articles such as walking sticks and umbrella.

This semi-flexible practical handle, on the main part a plane is set. In the waist of the side opposite to this plane the inner-sink space with U-shaped cross-section is provided, which stretches toward the plane and holds gel. A U-shaped inner clip flange is set with the two ends of the rubber lagging respectively corresponding to the two ends of the U-shaped groove to clip with it, which makes its waist seal the gel in the inner-sink space. A gland is used to make tightly press on the plane of the main part the extending part stretching in at the opens in the two ends of the rubber lagging, and fix it to the main part. Therefore, it is successful to solve the problem of seal of the sides of the rubber lagging. When the great force in needed, the external shape of its rubber lagging gets well with the holding of the man, which makes the fingers feel comfortable. Its rigid gland fixed with the main part directly touches the palm, which makes it easy to exert force. Because of the rigid gland's covering one side of the main part, it is convenient to avoid the gel and the rubber lagging to install the press buttons in the gland and the rubber lagging. It is not necessary to set the complicate seal structure for press buttons between the rubber lagging and the main part.

### BRIEF DESCRIPTION OF THE DRAWINGS

FIG. 1 is a structural schematic drawing for an embodiment of this utility model—semi-flexible handle;

FIG. 2 is a structural schematic drawing for the unfolding of the embodiment of FIG. 1;

FIG. 3 is a structural schematic drawing for the Cross-Section A-A of Embodiment of FIG. 1;

FIG. 4 is a structural schematic drawing for the Cross-section B-B of embodiment of FIG. 1;

FIG. 5 is a structural schematic drawing for another embodiment of the utility model—semi-flexible handle;

FIG. 6 is a structural schematic drawing for the unfolding of embodiment of FIG. 5; and

FIG. 7 is a structural schematic drawing for the Cross-section C-C of embodiment of FIG. 5.

### BRIEF DESCRIPTION OF THE PREFERRED EMBODIMENTS

### I. Embodiment One

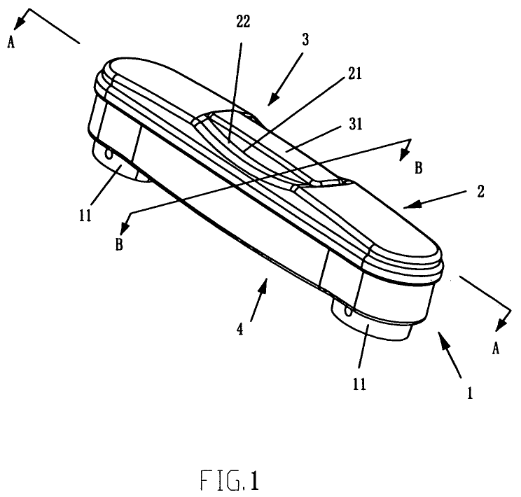

An embodiment of this utility model—semi-flexible handle is a handle for the extension rod for the cases or bags. Its structure is as shown in FIG. 1. This handle has a rigid plastic main part 1, a rigid plastic gland 2, a rigid plastic press button 3, a flexible rubber lagging 4 and gel 5 clipped in the vacant cavity defined between the main part and the rubber lagging. In each of the lower parts of the two ends of the main part 1, there is a pin 11 used to respectively link with the two extension rods. The rubber lagging 4 is installed between the two pins 11 in the lower part of the main part 1. The gland 2 is fixed in the upper part of the main part 1. The press button 3 is installed in the vacant cavity defined between the main part 1 and the gland 2 and the surface 31 of the press button appears from the via hole 21 in the concave arc 22 in the middle of gland 2.

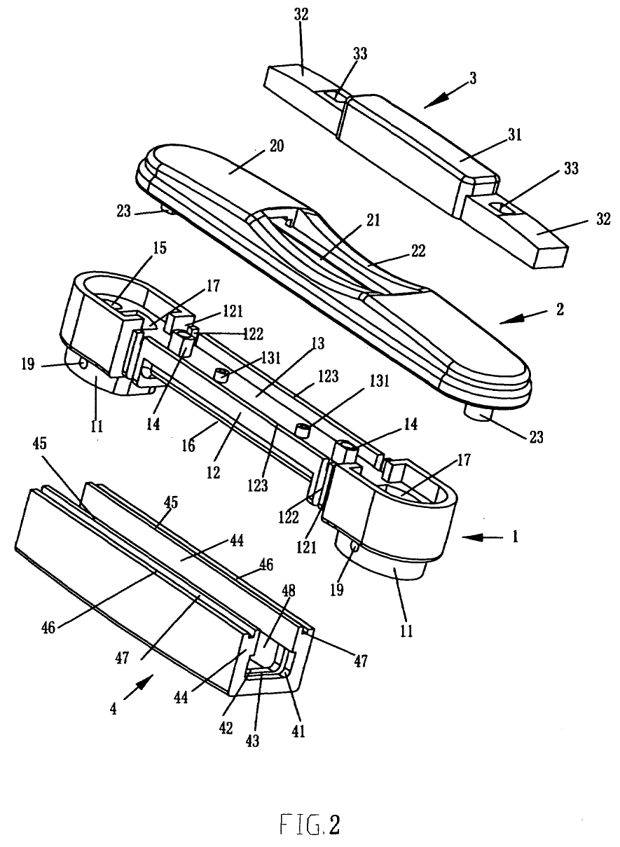

As for the structure for each part of this embodiment, referring to FIG. 2.

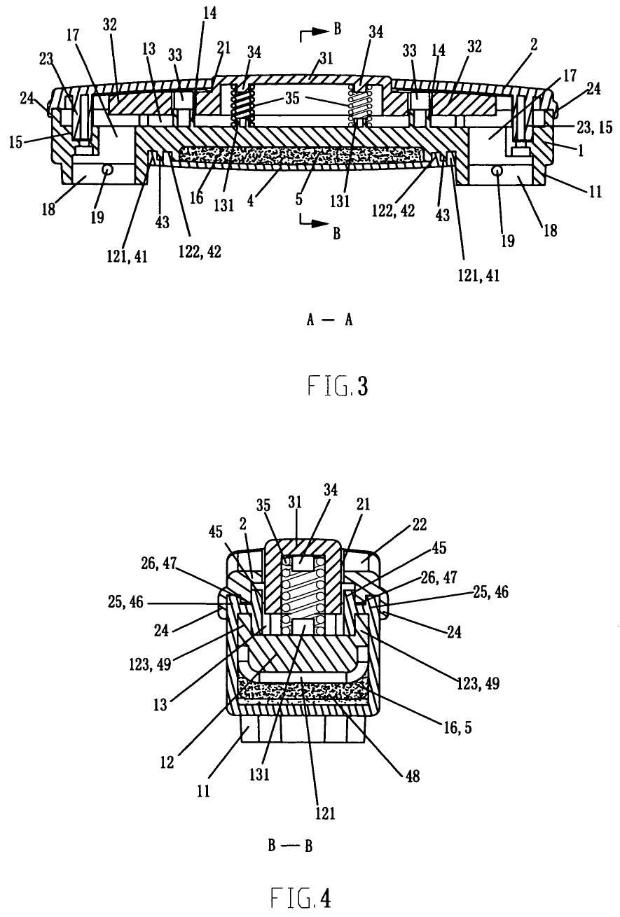

The rubber lagging 4 is the one whose cross-section is a long bar like a U. In the right and left ends ere respectively set the first inner clip flange 41 and the second inner clip flange 42 which raise inwardly, look like a U and stretch from the bottom to the neighboring two long sides. A U-shaped clip groove 43 is formed between the flanges of 41 and 42. The two sides of the rubber lagging 4 stretch inwardly at the opening. The extension part 44 are respectively formed in the two sides. The inner side in the upper part of each extension part 44 is a straight and horizontal and inner raised line 45 and the external side of the top is straight and horizontal and external raised line 46. Between the two raised lines of 45 and 46, a straight clip groove 47 is formed. The inner side of the rubber lagging is an open space 48. Referring to FIG. 4. There is a horizontal and straight, inner clip groove 49 in the root of the lower part of extension 44 of the space 48.

The main part 1 looks like a long bar. The part 12 for installing the rubber lagging 4 between the two pins 11 of its right and left ends of wholly sink inward. The first and second grooves of 121 and 122 which respectively stretch to front and back long sides and are U-shaped are respectively set in the right and left ends of the bottom long side. The bottom long side, the waists of its neighboring front and back long sides further sink inward to form the inner-sink space 16 which may is hold the gel 5. The long side in the top of the main part 1 is a plane, in which the groove 13 is cut to hold the press button 3. Two straight upper raised flanges 123 are formed between the front and back long sides and grooves 13, in the middle of which two raised dots located in the right and left ends to fix the spring and two raised guiding pillars 14 for the press button 3 to move up and down are set. An installing hole 15 and a via hole 17 are opened in each the two right and left ends of the bottom of the groove 13. The installing hole 15 is used to fixly install the gland 2 while the via hole 17 to establish the link between the press button 3 and inner locking parts of the extension rod. The inner holes 18 are used to cover and link the ends of extension rod while the horizontal holes 19 to install rivets for riveting the extension rod.

The gland 2 looks like a long bar, the bottom of which opens downwardly. In the periphery the hem 24 is provided which can cover the tops of the main part 1 and rubber lagging 4. The sink arc 22 is set in the middle of the gland 2. The hole 22 is set in the middle of the sink arc 22 for the raised press button surface 31 in the middle of the press button 3. Please refer to FIGS. 3 and 4. An inserting pin 23 stretches out from each of the lower sided surface closer to the right and left ends of the gland 2. A chute 25 is set in each of the lower portion of the front and back long sides of gland 2 to cut a clip flange 26 from the hem 24.

The middle of the press button 3 looks like a long bar in which the inner hole is set which opens downwardly. A lower horizontal pin 32 stretches out from the right and left sides of the press button 3, which makes the press button surface 31 raised. In each of the horizontal pins 32 there is a guiding hole 33. Please refer to FIGS. 3 and 4. In the bottom of the inner hole in the middle of the press button 3. The right and left dots 34 are set for fixing the spring.

As for the process of installing each part of the embodiment and their inter relation, please refer to FIGS. 3 and 4.

Referring to FIG. 3. First put the gel 5 into the inner sink space 16 of the main part 1, then insert the rubber lagging 4 into the inner sink part 12 between the two pins 11 of the main part 1 to ensure that the first U-shaped inner clip flanges 41 respectively at the right and left ends of the rubber lagging 4 respectively match and clip with the corresponding first U-shaped grooves 121 in the right and left ends of the main part 1. The second U-shaped inner clip flanges 42 respectively at the right and left ends of the rubber lagging 4 respectively match and clip with the second U-shaped grooves 122 of the right and left ends of the main part 1. The U-shaped clip groove 43 between the first and second inner flanges of 31, 42 in each of the two ends of the rubber lagging 4 respectively clip with the raised flange between the first and second grooves of 121, 122 in the same end of the main part 1. The double seal structure thus formed will guarantees the gel not to leak from both ends of the rubber lagging 4. Referring to FIG. 4. Connect the extension parts of the two sides of the rubber lagging 4 respectively with the upper side surface of the inner sink part 12 of the main part 1. The inner clip groove 49 in the root of the lower part of each of the extension parts 44 clip with the upper raised flange 123 in the inner sink part 12 to make the front and back inner walls closely touch the corresponding front and back long sides to form the seal structure of the front and back long sides. Thus, the gel will not leak from the front and back long sides of 20 the rubber lagging 4.

Referring to FIG. 3. A spring 34 will be installed in the right and left dots 34 for fixing the spring in the inner hole in the middle of the press button 3, then clip the free ends of the two springs 34 respectively with the corresponding locating points 131 in the groove 13 of the main part 1, and make the guiding holes 33 in the horizontal pins 32 respectively at the right and left sides of the press button 3 resepectively aligned with the corresponding guiding pillars 14 in the groove 13 of the main part 1. Make the via hole 21 in the middle of the gland 2 aligned with the press button surface 31 in the middle of the press button 3 and the inserting pins 23 respectively at the right and left ends of the lower portions of the gland 2 respectively aligned with the corresponding installing holes 15 in the groove 13 of the main part 1. Press the gland 2 downwardly to insert the inserting pins 23 respectively at the right and left ends of the lower portions of the gland 2 respectively into the corresponding two holes 15 above-mentioned, which compresses the springs and the right and left guiding pillars 14 of the main party 1 respectively stretch into the guiding holes 33 at the right and left horizontal pins 32 in the two sides of the press button 3. The hem 24 of the periphery in the bottom of gland 2 covers the top of the main part 1. Please refer to FIG. 4. Now the inner raised lines 45 at the upper ends of the extension parts 44, which stretch inwardly, in the front and back long sides of the rubber lagging 4, are inserted into the gland 2 with the external raised lines clipped into the chutes in the lower portions of the front and back long sides. The clip flanges 26 in the lower portions of the front and back long sides of the gland 2 are respectively inserted into the straight clip grooves 47 in the front and back long sides of the rubber lagging 4. The hem 245 of the lower portions of the front and back long sides of the gland 2 cover the top of the rubber lagging 4. The inserting pins 23 at the right and left ends of the lower portion of the gland 2 closely match with the right and left installing holes 15 of the main part 1, which fully tightly press the gland 2 to make the bottom of the straight clip grooves 25 in the lower portions of the front and back long sides respectively tightly lean against the external raised lines 46 respectively at the sides of the front and back long sides of the rubber lagging 4, which makes the bottom of the inner clip grooves 49 of the front and back long sides of the rubber lagging 4 respectively tightly lean against the upper end surface of the upper raised flanges 123 of the inner sink part 12 of the main part 1. In this way, the gel can be guarantee not leak from the front and back long sides of the inner parts of the rubber lagging 4. The press button surface 31 in the middle of the press button 3 passes through the via hole 21 in the middle of the gland 2 and exposes on the concave arc 22 of the gland 2.

When a man holds the handle according to the embodiment, the palm presses the handle of the gland 2 while the four fingers from forefinger to little finger lean against the rubber lagging 4. When we move or lift the case or the bag, each winding finger presses the rubber lagging 4, causing the gel 5 transformed by force. Thus, the external shape of the rubber lagging 4 gets well with the winding fingers, which makes them feel comfortable. What's more, the palm directly touches the gland 2 fixed with the rigid main part 1, which is easy for the man to exert force?

In this embodiment, because the gland 2 and the main part 1 are linked by means of transition fit with the inserting pins 23 and the installing holes 15. It is necessary to dismantle them. However, the inserting pins 23 and the installing holes 15 are also connected by static matching or sticky means, but after that, they are not allowed to be dismantled.

### II. Embodiment Two

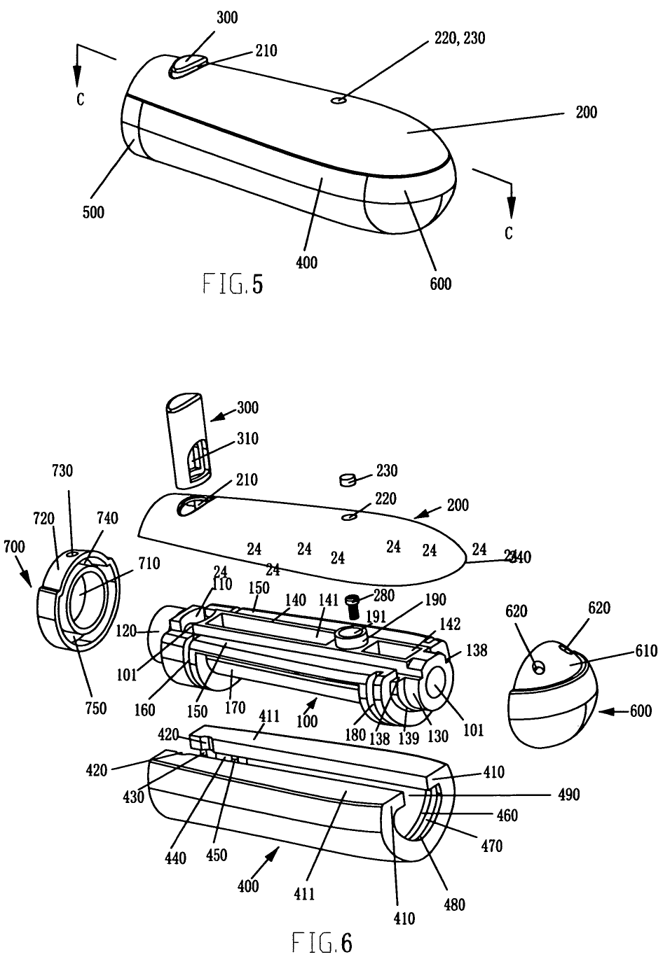

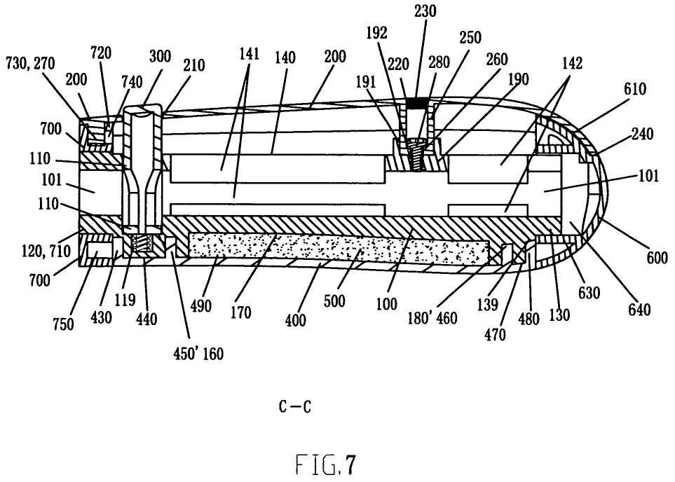

Another embodiment of the utility model—semi-flexible handle is one for an umbrella. Its external shape is as shown in FIG. 5. The structure of each part is shown as in FIGS. 7 and 6. The rigid plastic main part 100 hides among the rigid plastic gland 200, flexible rubber lagging 400, the rigid plastic tail hood 600 and the rigid plastic lid ring 700. The gel 500 is clipped in the vacant cavity defined between the main part 10 and the rubber lagging 400. There is a via hole 210 for the press button in the front part of the gland 200. The top of the press button 300 stretches out from the via hole 210. There is a small hole 220 in the middle and rear part of the gland 200, which is blocked up by the plug 230.

Please refer to FIGS. 6 and 7.

The press button 300 is a rigid hollow oval plastic tube. In the opening near its lower part is set a via hole 310 for the umbrella middle rod to pass through.

The gland 200 is a thin shell with the bottom 240 and the front end equaled and opened and its upper part rose like an arc. In the front of the press-button via hole 210 in the lower surface of the front part of the gland 200 there is a clip pillar 270 which stretches downwardly, in the lower surface at the small hole 220 in the middle and rear part of the gland 200 a tube 250 stretching out. There is a screw via hole 260 in the bottom center of the tube 250.

When the main part 100 is leveled, it looks like a long cylinder with its head cut smooth. Its middle part is a pass-through hole 101 used to install the umbrella middle rod. Its front is a truncated cone 120 used to install the lid ring 700 and its rear is an echelon truncated cone 130 used to install the tail hood 600. The press button hole 110 is vertically opened in the front of the upper plane 140 of the main part 100 corresponding to the via hole 210 in the front of the gland 200. The press-button hole 110 passes through the central hole 101 to reach the lower part of the main part 100. In the bottom of the press button hole 110 a blind hole 119 is made to install the spring. A raised truncated cone 190 is made in the middle and rear of the upper plane 140 of the main part 100 corresponding to the small hole 220 in the middle and rear of gland 200. At the center of the upper surface of the raised truncated cone 190 a blind hole 191 is made to hold the tube 250 in the lower surface of the gland 200. A screw hole 192 is set in the center of the bottom of the blind 191 corresponding to the screw via hole 260 in the bottom of the tube 250. A square pierce 141 is opened between the press-button hole 110 and the raised truncated cone 190 in the upper pane 140 of the main part 100 to reach the bottom side wall of the central hole 101. A square pierce 142 is opened between the raised truncated cone 190 and echelon truncated cone 130 to reach the bottom side wall of the central hole 101. These two pierces of 141 and 142 are used to decrease the consume of the raw material in the main part 100. The two sides of the plane 140 in the main part 100 stretch downwardly to become a long plane 150 to link the rubber lagging 400. A U-shaped groove 160, which connects the two long planes 150, is made in the front of the lower part located in the two long planes 150 of the main part 100 while in its rear A U-shaped groove 180, which connects the two long planes 150, is made. A long U-shaped grove 170, which does not connects the two long planes 150, is made in the waist of the middle, used to hold the gel 500. The two sides of the rear of the main part 100 each stretch downwardly to become chamfered groove 138 which is lower corresponding long plane 150. The two symmetry chamfered grooves 138 all cut into the large end 139 and periphery of the small end of the echelon truncated cone 130.

The semi-cylinder-shaped rubber lagging 400, with a U-shaped cross-section, the two sides stretch at the opening inwardly to form the two opposite extension parts 410. A recession groove 420 is opened in each the front of the inner sided wall of the two opposite extension parts 410 corresponding to the press button 300. A U-shaped inner clip flange 430 is set in the front of the rubber lagging 400 to correspond to the root of the truncated cone 120 in the front of the main part 100. A U-shaped inner clip flange is set in the groove 160 of the front of the corresponding main part 100 to clip with it. A U-shaped groove 440 is formed between the inner clip flange 430 and inner clip flange 450 of the main part 100, the rear of which sets a U-shaped inner clip flange 480 to correspond to the large end echelon 139 of the root of the echelon truncated cone 130 in the main part 100. A U-shaped inner clip flange 460 is set in the groove 180 in the rear of the main part 100 to clip with it. A U-shaped groove 470 is formed between the inner clip flanges 460 and 480 in the rear of the rubber lagging 400. The long waist U-shaped groove 490 is formed between the front inner clip flange 450 and rear inner clip flange 460 of the rubber lagging 400.

The Plastic tail hood 600 is a semi-sphere thin shell, in the periphery of the top of which a sink downward arc echelon 610 is opened to make room for the end of the gland 200. In the echelon 610 the two locating holes 620 respectively correspond to the two chamfered grooves 138 in the rear of the main part 100. The inner side of the tail hood 600 stretches foreword to be a tube 630 so as to cover and connect the small end of the echelon truncated cone 130 in the rear of the main part 100.

Lid ring 700 is a ring for matching the central hole 710 and the truncated cone 120 in the front of the main part 100. The periphery of its top is cut a sink arc echelon 710 so as to make room for the front of gland 200. A locating hole 730 is set in the echelon 710 to correspond to the clip pillar in the lower surface of the front of the gland 200. The circle shaped handicraft groove is set in the rear side of the lid ring 700 to reduce the weight. The external diameter of the upper section 740 of the circle shaped handicraft groove is small while the lower one 750 to make the thickness of each part of the lid ring 700 equally.

As for the process of installing of each part of this embodiment and their inter relation, please refer to FIG. 7.

First put the gel 500 into the long groove 170 in the inner sink space of the waist of the main part 100. Then open the extension parts 410 of the two sides of the rubber lagging 400 to make the recession groove 420 in its inner sided wall aligned with the press button hole 110 in the front of main part 100. The clip flange 430 in the front of the rubber lagging 400 is inserted into the root of the truncated cone 120 in the front of the main part 100. The inner clip flange 450 is connected with the groove 160 in the front of the main part 100. The bottom of the groove 440 in the front of the rubber lagging 400 touches the raised part of the front of the main part 100. The inner clip flange 480 in the rear of the rubber lagging 400 blockes the large-end echelon 139 in root of the echelon truncated cone 130 in the rear of the main part 100. The inner clip flange 460 is clipped with the groove 180 in the rear of the main part 100. The bottom of the groove 470 in the rear of the rubber lagging 400 touches the raised part in the rear of the main part 100. The long groove 490 in the waist of the rubber lagging 400 covers and holds the gel 500 and the two neighboring raised parts of the main part 100. The extension parts 410 of the two sides in the rubber lagging 400 are respectively connected with the long planes 150 of the two sides in the upper plane 140 of the main part 100.

Insert the inner-sided tube 630 of the tail hood 600 into the small end of the echelon truncated cone 130 in the rear of the main part 100, and turn the tail hood 600 to make the two locating holes 620 respectively aligned with the two chamfered groove 138 in the rear of the main part 100. When necessary, an axis is inserted into each of the two locating holes 620 and makes the two axes touch the vertical wall of the corresponding chamfered groove 138. After making sure the tail hood 600 correctly fixed in the rear of the main part 100, we press foreword the tail hood 600 to make the bottom of the periphery of the tail hood 600 and the bottom of the tube 630 lean tightly against the inner clip flange 480 of the rear of the rubber lagging 400 so as to make the double seal structure formed by the rears of the main part 100 and the rubber lagging 400 guarantee that the gel will not leak from the rear of the rubber lagging 400. The close transition fit can be adopted in the external of the small end of the echelon truncated cone 130 in the rear of the main part 100 and the inner tube 630 of the tail hood 600 and fixed by inserting and connecting. The clearance fit will also be adopted and fixed by stickiness.

Insert the central hole 710 of the lid ring into the truncated cone 120 in the front of the main part 100. Turn the lid ring 700 to make the center of the locating holes 730 and those of the press-button holes 110 and those of the round raised platform 190 in the same line. That's to say, the axis line of the locating hole 730 is vertical with the upper plane 140 of the main part 100. Press backward the lid ring 700 to lean the back side of the lid ring 700 tightly against the inner clip flange 430 in the front of the rubber lagging 400. The double seal structure formed by the fronts of the main part 100 and the rubber lagging 400 guarantee that the gel will not leak from the front of the rubber laging 400. The close transition fit can be adopted in the periphery of the truncated cone 120 of the front of the main part 100 and the central hole 710 of the lid ring 700 and fixed by inserting and connection. The clearance fit can also be adopted and fixed by stickiness.

Make the clip pillar 270 of the lower surface of the front of the gland 200 aligned with the locating hole 730 of the lid ring 700 and tube 250 with blind hole 191 in the round raised platform 190 of the main part 100. Press downward the gland 200 to make the clip pillar 270 wholly into the locating hole 730 of the lid ring 700 and tube 250 into the blind hole 191 of the raised truncated cone 90 of the main part 100.1 Put the screw 280 into the tube 250 to make the screw-driving grain part pass through the rivet via hole 260. Tightly lock the screw hole 192 in the blind hole 191 of the main part 100. The end part of the gland 200 is covered in the arc echelon 610 in the periphery of the upper part of the tail hood 600. The bottom 240 of the gland 200 tightly press on the upper surface 411 of the extension parts 410 of the two sides of the rubber lagging 400. Make the inner wall of the long groove 490 in the waist of the rubber lagging 400 tightly touch the two sides of the main part 100, which makes the seal of the two sides of the rubber lagging 400. Thus, the gel will not leak from the two sides of the rubber lagging 400.

Finally, put a spring into the blind hole 119 in the bottom of the main part 100. Then put the opening of the press button 300 downwardly and insert it into the press-button hole 110 via the press-button via hole 210 in the front of the gland 200. Then install the umbrella middle rod in the central hole 101. The umbrella middle rod passes through the via hole 310 in the press button 300. Thus, the umbrella middle rod will not come off the press-button via hole 210 in the gland 200 and the press button hole 110 in main part 100.

When we hold the handle according to this embodiment, our palm presses on the gland 200. The four fingers from forefinger to little finger are winding to lean against the rubber lagging 400. The drawing the winding fingers will presses the rubber lagging 400. The shape of the gel 500 will be changed. Thus, the external shape will get well with the each winding finger and make the fingers feel comfortable. Because the palm directly touches the gland 200 fixed with the main part 100, we feel very good. Drawing in the fingers or loosing them is very easy.

All mentioned above is only the better embodiments for this utility model, will not limit the range of it. Any equally effective changes or decoration made according to the technological plan and illustration booklet of the utility model should belong to the scope covered by it.

1. A semi-flexible handle, comprising: a rigid main part, a rubber lagging installed in the main part and a gel clipped in the vacant cavity defined between said main part and the rubber lagging, wherein in a waist of the first side an inner-sink space with a U-shaped cross-section is provided, which stretches toward an opposite second side and holds gel; in said main part, said second side opposite to said first side defines a plane; at the two ends of the first side in the main part, the U-shaped grooves are respectively provided, which stretch toward the second side; the cross-section of the rubber lagging is U-shaped, the inner-clip flanges of the two ends of the rubber lagging, which corresponds to the above-mentioned U-shaped grooves are respectively set and clipped with said grooves; the two sides of the rubber lagging stretch inwardly at the opening, the extending parts of said two sides are respectively linked onto the second side of the main part, said waist of the rubber lagging seals the gel in said inner-sink space of the waist of the main part, a gland tightly presses the extending parts of the rubber lagging on the second side of the main part, and said gland is fixed to the main part.

2. The semi-flexible handle according to claim 1, wherein the two U-shaped grooves which stretch to the second side are respectively provided at the both ends of the first side of the main part; the two inner clip flanges are respectively provided at both ends of the rubber lagging, two said flanges are clipped with two said grooves.

3. The semi-flexible handle according to claim 1, wherein the groove is provided in the second first side of the above-mentioned main part; the two upper raised flanges positioned in the two sided walls of the groove are respectively formed to get to the second side, an inner clip groove is provided in each of the roots of the bottom ends of the extending parts of the two sides of the rubber lagging, the extending parts of the two sides of the rubber lagging are respectively connected onto the second side of the main part, the inner-clip groove provided in each root of the extending-part bottom end is clipped with the corresponding upper raised flange.

4. The semi-flexible handle according to claim 3, wherein there is a straight clip groove provided in each upper part of the extending parts of the two sides of the rubber lagging; the straight clip grooves respectively divide the upper parts of the extending parts of the two sides of the rubber lagging into two raised lines stretching in the direction of the length; the bottom of the gland opens outwardly, and on the periphery a hem is provided which can cover and contain the tops of the extending parts of the two sides of the rubber lagging and the second side of the main part, in each of the two sides of the lower portion of the gland which stretch in the direction of length, a straight clip groove is provided which includes a clip flange from the root part of the hem, the gland presses tightly the two sides' extending parts of the rubber lagging on the second side of the main part, the raised lines formed inside the upper parts of the two extending parts of the rubber lagging are put into the gland, the outer raised lines are respectively clipped into corresponding chutes of the lower portion of the gland which stretch in the direction of the length, the clip flanges of the two sides of the lower portion of the gland are respectively put into the corresponding chutes in the rubber lagging which stretch in the direction of the length; the part, which stretches in the direction of length, of the hem of the lower portion of the gland, covers the tops of the two sides' extending parts of the rubber lagging.

5. The semi-flexible handle according to claim 4, wherein a via hole is provided in the above-mentioned gland for the top surface of the press button to pass through, the main part of the press button is installed in the space defined between the grooves of the second side of the main part and the gland.

6. The semi-flexible handle according to claim 5, wherein in the middle part of the press button above-mentioned the surface of the press button is raised; a horizontal pin stretches out from each of the two sides; in each horizontal pin, a guiding hole is set to match with the two raised guiding pillars to guide the up and down movement of the press button set in the grooves of the second side of the main part, the spring is set between the bottom of the press button and the grooves of the second side of the main part.

7. The semi-flexible handle according to claim 6, wherein the inner hole, which opens downwardly, is set in the middle of the press button above-mentioned; the spring is installed in the space defined between the bottom of the inner hole of the middle of the press button and the grooves of the second side of the main part.

8. The semi-flexible handle according to claim 1, wherein at least a withstanding mechanism is fixedly installed in one of the ends of the above-mentioned main part, this mechanism presses the end of the rubber lagging to the end surface of the main part in same side direction.

9. The semi-flexible handle according to claim 8, wherein the withstanding mechanism is a ring or lid, the ring or lid is fixed in the outer raised part of the middle of the same side's end part of the main part.

10. The semi-flexible handle according to claim 1, wherein the via hole is set in the gland above-mentioned for the end surface of the press button to pass through, in the press button via hole of the main part corresponding gland, the press button hole is opened, a spring is installed at the bottom of the press button hole, the press button which passed through the press button hole of gland is installed in the press button hole of the main part.

11. The semi-flexible handle according to claim 2, wherein the groove is provided in the second first side of the above-mentioned main part; the two upper raised flanges positioned in the two sided walls of the groove are respectively formed to get to the second side, an inner clip groove is provided in each of the roots of the bottom ends of the extending parts of the two sides of the rubber lagging, the extending parts of the two sides of the rubber lagging are respectively connected onto the second side of the main part, the inner-clip groove provided in each root of the extending-part bottom end is clipped with the corresponding upper raised flange.

12. The semi-flexible handle according to claim 2, wherein at least a withstanding mechanism is fixedly installed in one of the ends of the above-mentioned main part, this mechanism presses the end of the rubber lagging to the end surface of the main part in same side direction.

13. The semi-flexible handle according to claim 2, wherein the via hole is set in the gland above-mentioned for the end surface of the press button to pass through, in the press button via hole of the main part corresponding gland, the press button hole is opened, a spring is installed at the bottom of the press button hole, the press button which passed through the press button hole of gland is installed in the press button hole of the main part.
